(19) United States
(12) Patent Application Publication
(10) Pub. No.: US 2017/0255951 A1
(43) Pub. Date: Sep. 7, 2017

(54) Network Analysis of Aggregated User-Reported Same-Type Product Differences with Contextual Search

(71) Applicants: Samuel Evans Silver, Newton, MA (US); Jeffrey Brian Lander, Westfield, MA (US)

(72) Inventors: Samuel Evans Silver, Newton, MA (US); Jeffrey Brian Lander, Westfield, MA (US)

(21) Appl. No.: 15/449,992

(22) Filed: Mar. 5, 2017

Related U.S. Application Data
(60) Provisional application No. 62/304,245, filed on Mar. 6, 2016.

(51) Int. Cl. G06Q 30/02; G06F 17/30

(52) U.S. Cl. CPC G06Q 30/0204; G06F 17/30339

(57) ABSTRACT

A method is disclosed for aggregating user-reported differences (metrics) among same-type consumer products. User inputs define network analyses that facilitate product recommendations closely matching stated preferences (inputs). The output includes an indication of how well each recommendation matches the desired characteristics by relating it to a same-type product with which the user is familiar (contextual understanding).

### CROSS-REFERENCE TO RELATED APPLICATIONS

The present application relates to U.S. Provisional Patent Application Ser. No. 62/304,245, filed Mar. 6, 2016, which is hereby incorporated by reference in its entirety.

### BACKGROUND

Field of Invention: An increasing proportion of consumer purchases are being made online, yet e-commerce remains an uncertain proposition for consumers. Significant variances across sizing, and other product definition standards, make it difficult to know whether what one is looking at, is what one is looking for. While consumers of clothing, for example, are typically told the waist and inseam dimensions of trousers, or, even more abstractly, that a shirt is a ‘medium’, a dress a size 4, or a shoe a size 8, this information is not adequate to assure that the clothing will ultimately fit the way the consumer desires.

Prior art falls short in addressing two critical problems. Continuing with the example of clothing, first, making fit recommendations on the basis of body size or shape is inadequate because individual style preferences vary widely—there is no such thing as an ideal fit for everyone with a particular body type. (More generally, individual product preferences cannot be determined solely by sorting customers into pre-determined “pigeon-holes.”) Second, preferences for fit in clothing (or other characteristics in general) change because of circumstances of use and other factors. Desirable features of fit differ in clothing intended for a night out, or a walk in the woods. Because of changing preferences that exist for any individual, it is difficult to achieve satisfactory recommendations when assuming the consumer always wants the same characteristics in all new articles. With makeup or lipstick, defining labels such as “long-lasting” are non-specific. Is one brand's “long-lasting” as long-lasting as another's? Across many different types of products, qualitative descriptors—or non-standardized quantitative metrics—are insufficient to comprehensively characterize the nature of a product to the consumer.

To use an analogy from biology, taxonomy concerns itself with variations in the natural world, and organizes life forms by their differences. Individuals looking to select a product for purchase have a similar challenge. How might they differentiate among thousands of similar products on offer? Taxonomists do this by agreeing upon a single actual specimen as the “type standard” for each species. This example, called the “holotype,” is used by biologists as a basis of comparison for all members of that species. The holotype of the grey wolf, Canus lupus, is an actual individual wolf, selected in 1758 by Carl Linnaeus, the “father of taxonomy,” and preserved since then in a museum in Sweden. The holotype does not have to be a perfectly typical or ideal specimen, rather, it is selected because it is a convenient and well researched standard. Variation within the species is thereafter defined by comparison to the holotype. The system disclosed here uses a similar method for making comparisons, but rather than demanding a single “type standard” within each product species (say the species “jeans” or the species “lipstick”) it allows each user to define their own holotype for their convenience and understanding. Because the type standard is selected by each individual user, and is both convenient and well understood by the user, the system is both easy to use and exceptional in its explanatory power.

Description of Related Art: US 2009/0138377 A1 describes a method of fitting clothes by accessing body information from the user to create a 3D avatar and dressing it in clothing to create a visual representation of how the articles would fit. In this art, clothes preference selection and purchase history are considered when making recommendations. As described, this is problematic because it suggests that there is an ideal fit for the user, or that the user will only require one type of fit. Depending on how it is created, forming a 3D avatar may suffer from inaccuracy and bias, or limited access to technology. Using a 3D scanner in order to achieve an accurate representation of the user is limiting since scanning hardware is not widely available, and many users are self-conscious about having an archived 3D image created of their naked body. Alternatively, if the user submits self-measurements in order to create the avatar, there is a high likelihood of significant sampling error and therefore inaccurate representation. In US 2009/013877 A1 clothes size data is obtained from “sales site servers”—retail partnerships. The problem with this is that the scope of fitting recommendations is limited to products from the participating vendors. This means that discovery of new articles is limited, and that it is not possible to virtually “try on” items of non-participating vendors. Further, since too-small clothing items are more likely to be returned than too-large, vendors have an interest in biasing the provided sizing data.

Patents number US 2014/0358738 A1 and US 2014/0129373 A1 both contain language that adheres to the concept of “proper fit” Although in US 2014/0358738 A1 it is possible for a user to receive recommendations for other articles that may be labeled as different sizes from one another, each is meant to fit in the hypothesized “appropriate” way.

As in the initial example, US 2014/0358738 A1 also obtains clothes listings through manufacturer's partnerships, and although user feedback affects the recommendation system, the breadth of recommendations is still fundamentally limited.

US 2014/0129373 suggests articles where different customers have purchases in common. This method is successful when the user and a significant fraction of others from whom recommendations are being drawn have wholly overlapping and unchanging style preferences. This method (“pigeon-holing”) fails if the user is interested in changing their fit relative to their past purchase history, if changes in weight require a revision of desired fit, or if the user has different or unusual preferences than the aggregate affinity sample.

### BRIEF SUMMARY OF THE INVENTION

Here, a system and method is disclosed for aggregating user-reported differences between same-type products. Difference is expressed in metrics identified for the product category in question. Consumer reported comparisons are the key source of the product data used in the network analyses herein. Personal user data (such as body measurements), or the similarity of reported product ownership or familiarity (“pigeon-holing” with apparently similar individuals) play no role in the determination of recommendations. While there is nothing in our system that restricts the user from conducting a search with multiple queries utilizing different reference article starting points, the system disclosed here allows the user to select a single reference article with which they are familiar, and specify over a number of metrics how they would like to define a new product.

By creating a system that allows a consumer product to be compared with another product of the same type they already own and understand, it is possible to communicate to the consumer how any item is characterized compared to something with which they are already familiar. With this methodology, two things are possible: First, a consumer is able to find new items that match their desires by using a familiar product as a reference. This allows the discovery of previously unknown articles that adhere to specific characteristics that the user defines. Second, when the consumer is considering purchasing a specific item, the system allows the user to ascertain whether its characteristics are suitable by comparing a detailed set of its parameters against the familiar same-type product.

A critical function of the art described here is the capability to allow a user to identify new articles in a very specific manner, across metrics beyond those expressed in traditional sizing or product definitions, and in ways that the user personally defines. Additionally, the database from which all calculations are derived is populated by user-submitted comparisons between same-type products they own or with which they are familiar. Although any single user input may have a very high possibility of product sampling error, responses from a large number of users can be expected to be normally distributed and therefore at-scale regress to the mean and achieve a high degree of accuracy. This is a marked contrast from systems where a user provides personal body-shape information. In such systems, a single set of data experiences the fullest possibility of sampling inaccuracies, inevitably resulting in higher error rates in recommendations. As well, in the art described here, since metrics are provided by users not vendors, there is no limitation on the number of brands or products that can be considered.

### BRIEF DESCRIPTION OF THE DRAWINGS

FIG. 1: Depiction of hypothetical five node fit comparison network with clothing articles R, 1, 2, 3 and C and links representing individual user (consumer) reported fit differences between articles. The true fit difference between any reference item (R) with which a user if familiar and any comparison article (C) with which the user is unfamiliar can be approximated by calculating a weighted average of the mean of all 1st Degree of Separation (DoS), 2nd DoS and 3rd DoS linkages, where 1st DoS refers to direct R-C comparison, 2nd DoS refers to linkages utilizing one intermediary article (1, 2 or 3) and 3rd DoS refers to linkages utilizing two intermediary articles.

FIG. 2: An alternative representation of a five node fit comparison network which suggests a methodology for efficiently calculating the 1st, 2nd and 3rd DoS mean fit differences. Note that article M1=article N1, but M1 represents the article's appearance as the first (and perhaps only) intermediary article between R and C while N1 represents the article's appearance as a second intermediary article. Article C appears three times as the end point of 1st DoS, 2nd DoS and 3rd DoS linkages.

FIG. 3: Descriptions of the mathematical steps used in the calculation of mean reported differences for pure 1st Degree, 2nd Degree and 3rd Degree comparison networks.

FIG. 4: A simple 1st DoS network consisting of two user reported (P=2) differences for articles R and C.

FIG. 5: A simple 2nd DoS network consisting of one reported difference between articles R and M (where M is an intermediary between R and C), and one reported difference between articles M and C.

FIG. 6: A more complex generalization of a 2nd DoS network where there are reported differences between articles R and M from Phi=2 users and reported differences between articles M and C from Omega=3 users. In this network, the total number of unique network paths from R to C is (Phi×Omega)=(2×3)=6.

FIG. 7: Combining 1st, 2nd and 3rd DoS results in the final preparation for the creation of the product category relationship table. DoS weightings used in this calculation will be adjusted to reflect, at a minimum, the relative confidence placed in the calculated 1st, 2nd and 3rd DoS means and the total number of unique paths from R to C included in each DoS network.

FIG. 8: Use of the product category relationship table to generate three of many possible result formats that might be supplied to a user.

### DESCRIPTION

Components of the best mode include—

a) A Collection of Data from System Users:
Referent Product (R): Brand, style, retailer's size
Comparison Product (C): Brand, style, retailer's size
The Fit Differences (D): For each category of product (pants, shirts, jackets, etc.), a collection of metrics are developed that embody the fit differences experienced by the user. For example, the metrics for pants might include the difference in thigh fit, calf fit, leg opening, and drop. Users are asked to quantify the difference across each metric for each R:C combination of products being compared. The set of metric values specifying the fit difference in product C when compared back to product R is represented as D(R,C).

Mathematically, the relationship between the fit of R and the fit of C can be described as:

R+D(R,C)=C

The inverse relationship can also be inferred:

C−D(R,C)=R

This added information might enhance the value of information that is collected, especially as new products arrive on the scene.

### b) The Relationship Network:

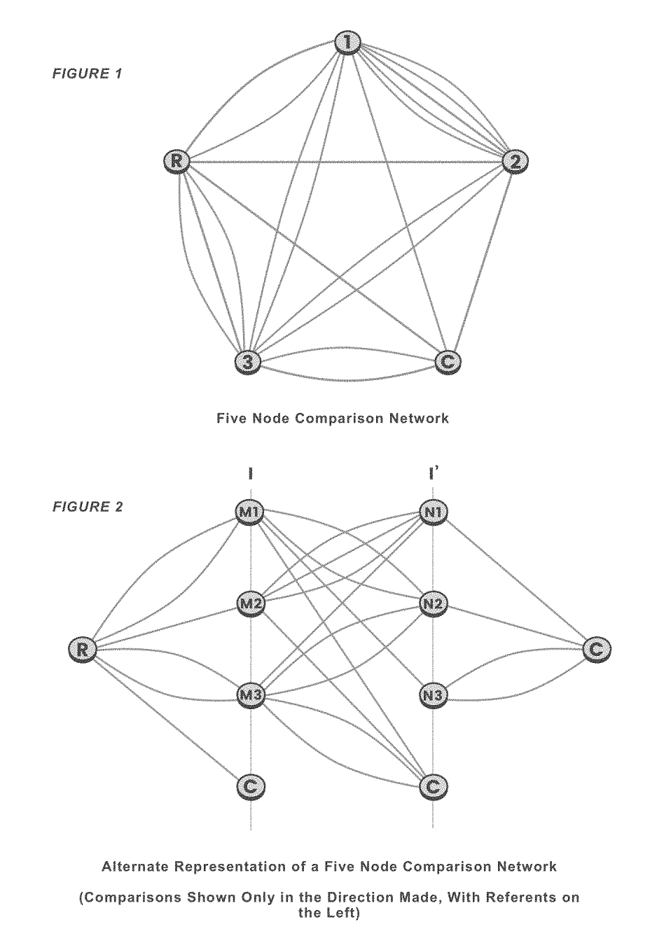

Conceptually, the collected user data can be utilized to create a network of comparisons between same-type products. Each network node represents a specific and unique item. Each link between nodes represents the differences reported by a single user for the products represented by the connected nodes. See FIG. 1 for a five node graphic illustration.

### c) Network Analysis:

Once implemented, the network can be analyzed by traversing the paths (P) between any two products (nodes) and calculating the mean difference (D-mean) reported among all the paths. Paths may include direct links between the two products (1^{st} degree of separation), paths with a single intermediary product (2^{nd} degree of separation) and paths with more than one intermediary product. To formalize our definitions:
1 degrees of separation refers to direct product comparisons.
2 degrees of separation refers to comparisons of R and C that are inferred by mutual direct comparisons with an intermediate product M. The differences D(R,M) and D(M,C) are added to produce the value D(R,C).
3 degrees of separation refers to comparisons of R and C that are inferred by indirect comparisons through two intermediate products M and N. In this case, the differences D(R,M), D(M,N) and D(N,C) are added to produce the value D(R,C).

Network analysis will be limited to 1, 2 and 3 degrees of separation. While direct comparisons seem most reliable, allowing higher degrees of separation will enrich the connectedness of our network, and thus the potential richness of the output. For example, the system will be able to suggest alternatives for which direct comparisons do not exist. However, errors may be larger in calculations involving higher degrees of separation, so a weighting scheme favoring direct comparisons will be implemented and, in this example, the 3 degrees of separation limitation will be observed.

### d) Rules for Network Analysis:

Only paths of 1, 2 or 3 degrees of separation will be considered.

### e) Revisualization of the Fit Relationship Network for Greater Understanding of the Processing Approach:

The five node fit relationship network is re-visualized in FIG. 2 with separate planes 1 and 1′ representing the 1^{st} and 2^{nd} degree &separation processing steps. The 3^{rd} degree of separation processing step is represented by the lone C-node at the far right of the diagram. In reality 3rd degree calculations involve all (N−1) products with which R can potentially be compared, but for ease of understanding, we are limiting ourselves to the D(R,C) case with its singular start and end points.

### f) Calculating the Mean Difference:

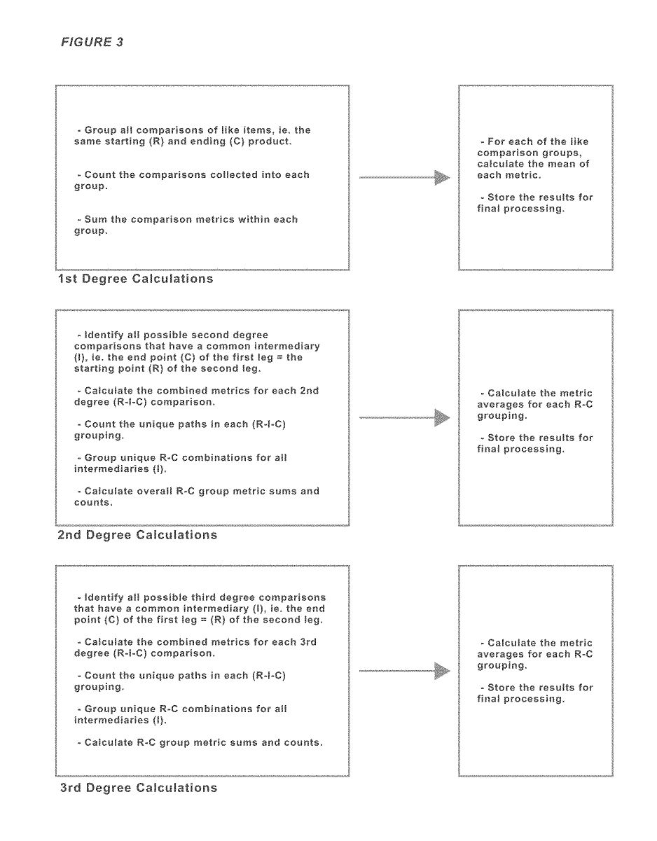

As illustrated in FIG. 2, plane I represents the N−1 products that R can be compared to in the 1^{st} degree calculations. This plane (less C) also serves as the set of intermediaries available to our second degree calculations. Likewise, plane I′ represents both the N−1 products that R can be compared to in the 2nd degree calculations and (without C) the set of intermediaries available to our third degree calculations. Comparison referents are always shown at the left end of each link. An individual user may select any brand-style-size product to serve as their referent. Note, the links shown from plan I′ to the final C are shown for the second time so that all 3^{rd} degree paths can easily be visualized. By definition, a 3^{rd} degree path is different than any 2^{nd} degree path.
1st Degree of Separation (see FIG. 3)

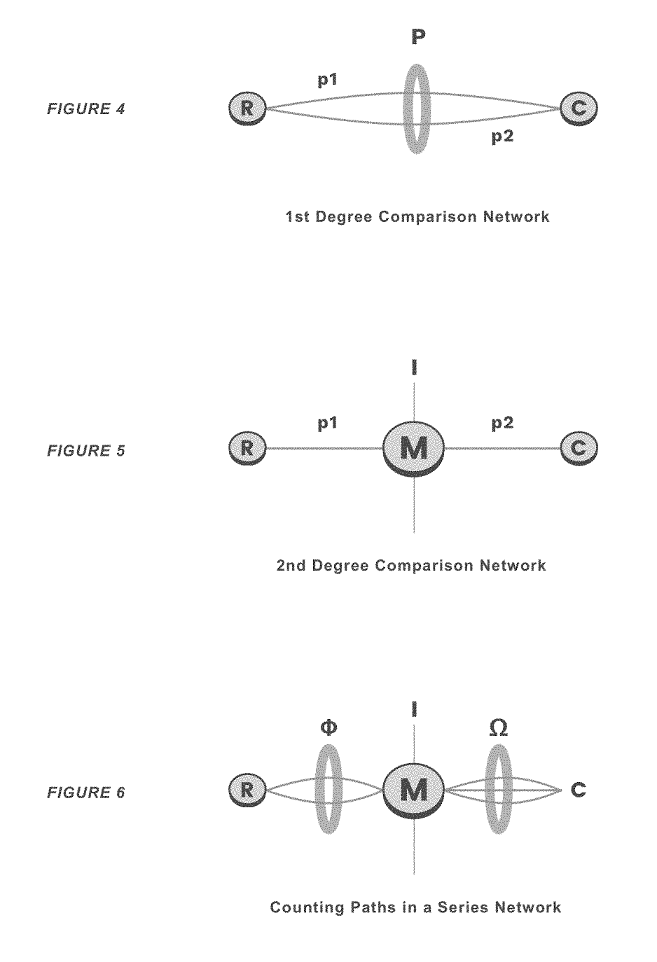

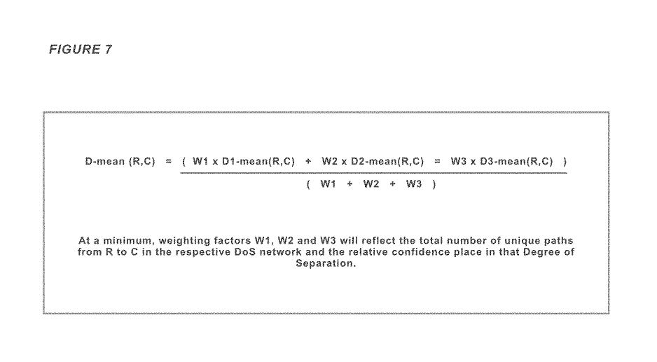

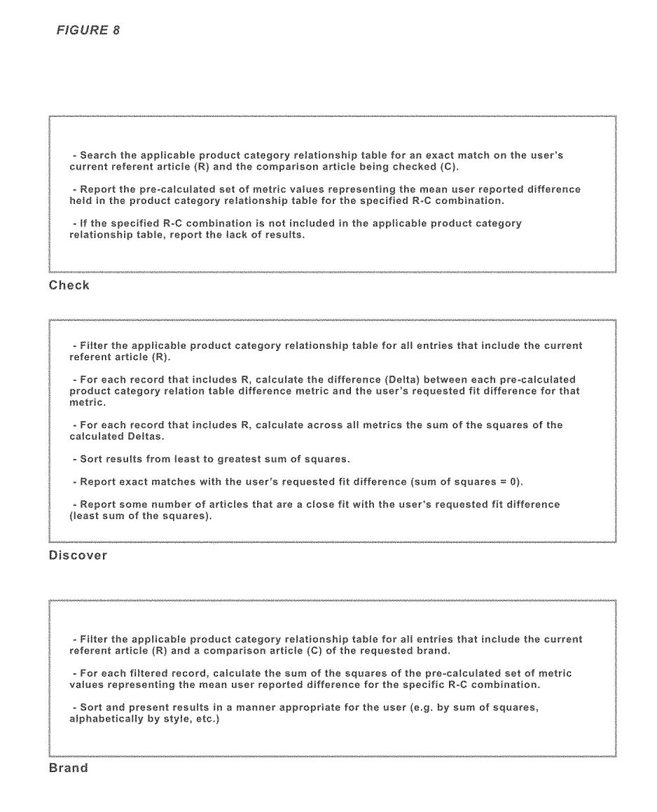

D1−mean(R,C)=D−sum(R,C)/P [Equation 1]
Where P is the number of network paths between R and C (for the 1st degree, P=the number of participants reporting a direct comparison of the two products.)
2nd Degree of Separation (see FIG. 4)
   Second degree calculations are greatly simplified by the understanding that for any single intermediary I,

Di−mean(R,C)=D−mean(R,I)+D−mean(I,C) [Equation 2]
See attachment A for a derivation of Equation 2.

Pi(R,C)=P(R,I)×P(I,C) [Equation 3]

D2−mean(R,C)=Σ(Di−mean(R,C)×Pi(R,C))/Σ(Pi(R,C)) [Equation 4]
Where Σ means the sum over I,
And Pi(R,C) means the paths from R to C via I.
This understanding means that we don't have to start from scratch, identifying and processing all of the unique 2^{nd} degree paths from R to C. Instead, we create a query that calls our 1^{st} degree of separation results twice. The tails of one input are connected to the matching heads of the second and Equation 1 is utilized to calculate the combined mean differences, one intermediary at a time. We then group on like starting and end products for all intermediaries and calculate the total D2−mean(R,C) using Equation 4. Note that it requires two queries to calculate the new D-mean values because the path count and element groupings must be complete before the new D-mean values can be calculated.
3rd Degree of Separation (see FIG. 5)

Di−mean(R,C)=D-mean(R,I′)+D−mean(I′,C) [Equation 5]
Similar to our processing of 2^{nd} degree values, we create a query that calls both our 2^{nd} degree and 1^{st} degree of separation results. The tails of the 2^{nd} degree input are connected to the matching heads of the 1^{st} degree input and Equation 5 is utilized to calculate the combined mean differences, one intermediary at a time. We again group on like starting and end products for all intermediaries and calculate the total D3−mean(R,C) in a manner similar to Equation 3 and Equation 4.
Combining the 1^{st}, 2^{nd} and 3^{rd} Degree Values
   A weighting scheme has been devised that includes the values of 2^{nd} and 3^{rd} degree calculations, but reduces their role as better direct comparisons become available. The contribution of 1^{st} and 2nd degree of separation weighting factors are removed from the denominator if there is no contribution to the numerator.

D−mean(R,C)=(W1×D1−mean(R,C)+W2×D2−mean(R,C)+W3×D3−mean(R,C))/(W1+W2+W3)
W1, W2 and W3 will adjust to meet the needs of the network. At a minimum, W1, W2, and W3 will reflect the relative confidence placed in calculated 1st, 2nd and 3rd DoS means and the total number of unique paths from R to C included in each DoS network.
Due to the nature of database queries, the processing of D-mean can be done ‘en masse’ for all possible (R,C) combinations. This opens the door for efficient pre-processing and creation of Product Category Relationship Tables that contain mean user reported difference data for all (R,C) product category combinations. Specific product category relationship tables are then available for user initiated queries.

### g) Processing the Fit Relationship Network:

For a single degree of separation, it is possible to construct a query that will process the data for all possible R-C combinations in a single pass (FIGS. 3, 4 and 5). However, a second query is required to calculate the resulting metric means for the degree of separation, primarily because this calculation must wait until the metric sums and the count of comparison paths are complete. The same is true for second and third degree of separation calculations.

### h) Storing the Results:

In any one product category, a single user can be anticipated to submit data for a small number of referent items and no more than one or two dozen comparison items. On average, this can be expected to be a small and relatively constant amount of data (K1). Therefore, the total amount of data collected will roughly be K1×U, where U is the number of participating users. Since U has the unrestricted potential to grow, the maximum data collected will be of the order of the number of users, O(U), and could become large.

In any product category, N unique products have the potential of being compared with each of (N−1) other unique products, for a total of (N×(N−1)) comparisons to be contained in a product category relationship table. Processing for each specific comparison of products will generate a small, relatively constant set of data (K2) including mean metrics and a count of the unique comparison paths analyzed. Therefore, the maximum amount of data generated is K2×(N²−N). Considering only the largest term, the comparison data generated will be of the order of N², O(N²). While N is much smaller than U, N² still has the potential to grow fairly large. However, for a single user with a small number (K3) of referent items, the size of the relevant processed data is (K2×K3×(N−1)), which is a much smaller order of N, O(N). This relatively manageable processed data subset allows a fairly autonomous App which contains only the processed data relevant to the user. Connectivity to the product category relationship tables would be required for submittal of user data, periodic updates to calculated metric means, and changes in the user's profile.

i) Popularity:

The popularity of an item is a measure of its appearance in closets similar to yours. Closet similarity is determined by the presence of one or more like brand-style-size articles in each person's listing of referent and compared items. Therefore, closet similarity takes into account both brand-style preferences and size.

Once closet similarity has been established, a popularity value is added to each article listed from the similar closet with an additional popularity adder for articles that are listed as referents for that closet

The primary use of popularity is as a secondary sorting criteria (after fit difference) when displaying search results. A low popularity, even zero, will not stop an item from appearing in search results. It could however impact the product's placement in the search results.

1. The method described herein of consumer-reported data aggregation and network analysis for the creation of specific Product Category Relationship Tables (database tables) that allow for any product to be contrasted to any other product of similar type across a series of standardized metrics.

2. The method as claimed in claim 1, wherein a consumer accessing a product category relationship table may search for articles with particular characteristic (metric) differences (D), defined by the consumer, in reference to an item of the same type possessed by, or well known to the consumer.

3. The method as claimed in claim 2, wherein the user is not required to have found a reference item where they are satisfied with the product characteristics.

4. The method as claimed in claim 2, wherein the results are displayed by the correlation with other individuals having like items.

5. The method as claimed in claim 1, wherein a consumer accessing the database may check the characteristic (metric) differences (D) of a specific item in reference to an item of the same type possessed by, or well known to the user.

6. The method as claimed in claim 1, wherein a consumer accessing the database may check the characteristic (metric) differences (D) of each style offered by a specific brand in reference to an item of the same type possessed by, or well known to the user.
